(19) United States
(12) Patent Application Publication
(10) Pub. No.: US 2004/0180800 A1
(43) Pub. Date: Sep. 16, 2004

(54) Cleaning and protecting composition with antioxidant and UV light resistance and method of use

(76) Inventor: John Marshall McMahan, Fountain Inn., SC (US)

Correspondence Address: JASON A. BERNSTEIN, POWELL, GOLDSTEIN, FRAZER & MURPHY LLP, 16TH FLOOR, 191 PEACHTREE STREET, NE, ATLANTA, GA, 30303-1736, US

(21) Appl. No.: 10/385,233

(22) Filed: Mar. 10, 2003

(51) Int. Cl. C11D 1/00

(52) U.S. Cl. 510/201

(57) ABSTRACT

An aqueous composition suitable as an automobile exterior cleaner comprising about 1% to about 5% by weight of an alkyl glycoside surfactant; from about 0.05% to about 5% by weight of an antioxidant; from about 0.02 to about 5% by weight of an ultraviolet absorber; from about 0.01 to about 10% by weight of a commercially available surfactant blend; from about 0.005% to about 1% by weight of an antimicrobial preservative; from about 0% by weight to about 8% by weight of magnesium chloride or magnesium sulfate heptahydrate, and the balance of the formulation being water with less that 2% by weight of the formulation being fragrance and colorant components. The composition reduces dulling of the gloss caused by antioxidants and ultraviolet light.

### FIELD OF THE INVENTION

The present invention relates to cleaning compositions, such as those commonly used for cleaning exterior painted and coated surfaces for automobiles. More particularly, the present invention relates to cleaning compositions incorporating antioxidant and UV light blocking components.

### BACKGROUND OF THE INVENTION

Current commercially available automotive cleaning compositions fall into categories such as “car wash” or “wash and wax” type products. While wash and wax products provide some functionality in gloss enhancement, with the implication of gloss protection, none make the claim of protecting against ultraviolet radiation, which is known to degrade surface finishes.

Ultraviolet radiation protection is provided by components which absorb ultraviolet radiation, components which act as free-radical (generated by the ultraviolet radiation in surface coatings) scavengers, and by antioxidants, which inhibit oxidation of surface coating components from the ultraviolet radiation.

Components which accomplish ultraviolet radiation absorption are typically from the family of arylbenzotriazoles or benzophenones. Antioxidant components are from synthetically produced materials or “naturally-derived” materials. Synthetic materials such as butylated hydroxytoluene or a cinnamic acid ester can be used. Additionally, there are many types of “naturally-derived” antioxidants such as Vitamins A and E, or a multi-ingredient mixture such as orange wax, also known as orange peel wax. Within orange wax itself, there are the antioxidant components trihydroxy-flavanone, trihydroxy-methoxyflavanone, ferrolic acid, and caffeic acid. Orange wax is also available in “light ends” and “heavy ends” forms which provide additional benefits in formulation, as they are more fluid than typical orange wax.

The ultraviolet absorption components as well as the antioxidant components are minimally soluble in water, and must be solubilized in an aqueous solution with the use of surfactants, as commonly found in automotive surface cleaning preparations. Their relative insolubility in water and oleophilicity would provide some attachment to coated surfaces, themselves being relatively oleophilic.

Ultraviolet light blocking and antioxidant compositions have been used or incorporated for application in different situations, such as skin to reduce the cancer causing and aging effects of the sun, in the formulation mix of colored polymers to reduce color fading caused by UV light degradation of the pigments, and the like. Such uses require specific formulations unique for the particular surface for which the use is desired. For skin, the composition is expected to absorb into the skin, leave little residue, and be able to withstand some contact with fresh, sea and chlorinated water without substantial diminution of blocking properties. However, skin applications of sun block are typically not expected to last more than a day, with many providing instructions to reapply to the skin after being in the water or after a few hours of use. With pigments and polymers, the UV and antioxidant must be sufficiently soluble and mixable with the polymer and pigment/colorant formulation so as to not diminish material properties or come out of solution.

Automotive paint finishes are designed to seal and protect the coated surface, such as steel, aluminum, plastic and the like. Such painted surfaces are typically solid, nonporous, nontacky and nonabsorptive. Developing a composition that provides both cleaning and long term protective properties must anticipate the need for solubility (so that the cleaner and dirt can be washed off) as well as the ability of the UV blocking and antioxidant components to remain on the surface for an extended period of time to provide effective protection. Thus, automotive paint finishes have very different properties than human skin or polymeric liquids. Application of cleaning and protective compositions must be formulated to take into account the different surface chemical and physical properties.

Several patents have issued discussing cleaning and protecting compositions.

U.S. Pat. No. 6,214,783 discloses the use of magnesium ions in liquid detergent and the use of UV absorbers as adjuvants. U.S. Pat. No. 5,972,867 discloses the use of magnesium ions and polyalkyl glucoside and the improved cleaning performance using magnesium. U.S. Pat. No. 6,432,395 discloses the use of polyalkyl glucosides and an alkyl glucoside component for streak-free rinsing. U.S. Pat. No. 6,506,715 discloses the use of UV absorbers listed with adjuvants, but not as a functional components. U.S. Pat. No. 5,501,815 discloses the use of alkyl polyglucoside as a rinse agent. U.S. Pat. Nos. 6,403,061 and 6,409,998 disclose UV blocking compositions for skin and hair.

It would be desirable to have a cleaning composition capable of removing commonly accumulated dirt, oil and other matter while imparting UV protection and reducing oxidant effects.

It would also be desirable to have a cleaning composition which would provide immediate cleaning properties and long lasting UV blocking and antioxidant protection properties.

### SUMMARY OF THE INVENTION

Generally described, the present invention provides in a first exemplary embodiment a wash composition for the exterior of automobiles. The composition comprises a wash surfactant, along with a rinse and gloss-enhancing agent (alkyl glycoside), ultraviolet absorber, and antioxidant, along with an agent that promotes free-rinsing and gloss enhancement provides some protection from ultraviolet radiation to painted surfaces.

The composition may also include fragrance and/or coloring agents as well as a preservative, antimicrobial and/or chelating agent.

The composition of the present invention may also be used or adapted for us on other treated surfaces, such as outdoor furniture, leather, vinyl, plastic, polymeric, composites, glass, ceramic and the like. The present invention may be adapted, such as by adding borax, for use on wood grain surfaces to clean, protect and condition the wood as well as make it more resistant to fungi and insects.

Other features and advantages of the present invention will become apparent upon reading the following detailed description of embodiments of the invention, when taken in conjunction with the appended claims.

### DETAILED DESCRIPTION OF THE INVENTION

The present invention generally provides an aqueous composition comprising water, a surfactant or surfactant blend, an alkyl glycoside, and either or both of a UV absorbent or antioxidant. Preferably, the composition also includes at least one of the following: a fragrance, a colorant, a chelating agent, such as a free-rinsing chelating agent, a preservative, and an antimicrobial preservative agent. It is to be understood that the terms “a” and “an” are intended to mean one or more.

The surfactant of the present invention is preferably anionic. Surfactants usable in the present invention include, but are not limited to, at least one of the following: any of the anionic surfactants, such as, but not limited to, linear alkyl sulfonates, alcohol ether sulfates; amphoterics such as, but not limited to, betaines; nonionics such as, but not limited to, octyl and nonyl phenol ethoxylates having an average of 9-12 moles of ethylene oxide; linear alcohol ethoxylates with an alcohol chain length of 6-14 carbon atoms and an average of 7-12 moles of ethylene oxide, and block co-polymers of ethylene oxide and propylene oxide, ammonium lauryl sulfate, ammonium laureth sulfate, cocamidopropyl betaine, cocamide DEA, mixtures of the foregoing and the like. A blend of ammonium lauryl sulfate, ammonium laureth sulfate, cocamidopropyl betaine, cocamide DEA is commercially available as Sulfochem™ AEG manufactured by Chemron, Inc. (Paso Robles, Calif.). Typically, this blend as commercially available would be incorporated into the composition in an amount of from about 3 to about 10% by weight, preferably from about 4 to about 8% by weight, as commercially available. Typical commercial alcohol sulfates include alkali metal, alkaline earth metals or ammonium salts of sulfate esters of C₈-C₁₂ alcohols, such as, but not limited to, sodium laurylsulfate, sodium 2-ethylhexylsulfate, lauryl triethanolammonium sulfate, sodium octylsulfate, mixtures thereof and the like. This component contributes to the cleaning properties of the composition of the present invention.

A co-surfactant, such as, but not limited to a silicone surfactant such as those manufactured by Crompton/Osi and Lambent Technologies, fluorosurfactants such as Zonyl™ FSH, FSA, and FSO manufactured by DuPont and the Flexiwet™ line manufactured by Innovative Chemical Technologies. Preferably, an alkyl glycoside is used as the co-surfactant, such as, but not limited to, Glucopon™ 425, an aqueous solution of alkyl polyglycosides (425N is d-glucose,decyl,octyl ethers-oligomeric, d-glucopyranoside, and C₁₀₋₁₆ alkyloligomer) based on natural fatty alcohol C₈-C₁₄, available from Cognis (Cincinnati, Ohio), of from 1% to about 5% by weight, preferably from about 1.5% to about 4%. Other companies which produce alkyl glycosides include, but are not limited to, KAO, Akzo Nobel, Seppic and the like. This component of the present invention provides the benefits of non-streaking and non-filming of cleaned surfaces by reducing surface tension reduction, cleaning, assisting in product stability, being mild (e.g., nonabrasive) to plastic surfaces and providing good rinsing properties.

Ultraviolet light protection is provided by a compound or mixture from the arylbenzotriazole and/or benzophenone families. One of the ultraviolet protection components contemplated as suitable for use in the composition is provided by a benzotriazole dispersion. One commercially available version of this is Flexisorb™ AQ-50, available commercially from Innovative Chemical Technologies of Cartersville, Ga. The amount of this component in the composition is from about 0.02% to about 5% by weight and preferably from about 0.1% to about 2% by weight as commercially available. This benzotriazole dispersion is preferred as it forms microemulsions when diluted in water, and is water insoluble, so is more durable than water-soluble ultraviolet absorbers and would also tend to attach, adhere, coat, bond or plate to an automotive painted surface.

Antioxidants may be synthetic or “naturally-derived” antioxidants such as Vitamins A and E, or a multi-ingredient mixture such as orange wax, also known as orange peel wax. Within orange wax itself, there are the antioxidant components trihydroxy-flavanone, trihydroxy-methoxyflavanone, ferrolic acid, and caffeic acid. Orange wax is also available in “light ends” and “heavy ends” forms which provide additional benefits in formulation, as they are more fluid than typical orange wax. One such formulation is commercially available from Koster Keunen, Inc. (Watertown, Conn.). The antioxidant component is present in the composition preferably at a level of about 0.05% by weight to about 5% by weight, more preferably from about 0.1% by weight to about 2% by weight.

The composition of the present invention may also preferably contain any suitable commercially available preservative, such as, but not limited to, dimethyl dimethyl hydantoin, glutaraldehyde, 5-chloro-2-methyl-4-isothioazolin-3-one, 2-methyl-4-isothiazolin, or benzisothiazolin, mixtures thereof and the like. The preservative is preferably present in a concentration of from about 0.01% by weight to about 1% by weight.

The composition may also contain a free-rinsing chelating agent such as, but not limited to, sodium salts of ethylenediamine tetraacetic acid or sodium salt of polyacrylic acid at a level of from about 0.05% by weight to about 4% by weight to aid in hard water chelation.

Fragrances and colorant components, as are known to those skilled in the art, may also be included in the composition. One exemplary colorant is Liquitint™ Brilliant Orange (Milliken, Spartanburg, S.C.). An exemplary fragrance is ORANGE BLAST™ fragrance 91140 from Intarome (Norwood, N.J.).

Magnesium salts may optionally be included in the composition of the present invention. Magnesium salts are effective for foam building in anionic systems, providing synergistic detergency with alkyl polyglucosides and certain anionics, and building viscosity in the product, without the corrosive potential of commonly used sodium chloride for the same purpose. Exemplary salts include, but are not limited to, magnesium chloride, magnesium sulfate heptahydrate and mixtures thereof.

In one exemplary embodiment of the present invention an aqueous composition is provided comprising about 1% to about 5% by weight as commercially available an alkyl glycoside surfactant; from about 0.05% to about 5% by weight of an antioxidant; from about 0.02 to about 5% by weight of an ultraviolet absorber; from about 0.01 to about 10% by weight of a commercially available surfactant blend; from about 0.005% to about 1% by weight of an antimicrobial preservative; from about 0% by weight to about 8% by weight of magnesium chloride, magnesium sulfate heptahydrate or a mixture thereof, and the balance of the formulation being water with less than about 2% by weight of the formulation being fragrance and colorant components, as are known to those skilled in the art.

The composition of the present invention is preferably formed, in one exemplary embodiment, by first mixing the ultraviolet light component(s), e.g., orange wax, and the alkyl glycoside, e.g., Glucopon, and, after this forms a solubilized mixture, adding it to the remaining components and mixing at room temperature. The formulated composition remains in solution for extended periods of time.

The present invention also provides a method of cleaning and protecting a surface, comprising the steps of (1) wetting the surface to be cleaned and protected; (2) applying to the surface a composition according to the present invention as described above; (3) rinsing the surface with water; and (4) allowing the surface to dry.

One advantage of the present invention is that the composition provides the immediate cleaning properties necessary for a cleaning composition, yet also provides long lasting UV and antioxidant protective properties which remain after the treated surface has been rinsed. Thus, with the present invention a single composition and a single treatment is possible; i.e., one does not need to clean, rinse, dry and then subsequently apply a separate protective composition. Accordingly, the present invention saves the user time and effort. An additional advantage of the present invention is that it may also provide resistance to corrosion, such as that caused or facilitated by exposure to salt.

The present invention as described, or as may be modified by those skilled in the art, may be used on other surfaces to clean and protect. Such surfaces include, leather, vinyl and plastic, such as that found in car interiors, plastic, polymeric, composites, glass, ceramic, coated and painted outdoor furniture and the like.

Also, the present invention may include borax and formulated for use as a cleaner and protection of wood products, such as outdoor furniture. Borax may provide the added properties of being an antifungal and insecticidal or insect repellant as well as a free radical scavenger. Borax may also be used in non-wood use as a corrosion inhibitor.

The invention will be further described in connection with the following examples, which are set forth for purposes of illustration only. Parts and percentages appearing in such examples are by weight unless otherwise stipulated.

### EXAMPLES

### Example 1

### Formulating

| Component | % by weight |
|---|---|
| Water | 88.57 |
| DMDM Hydantoin | 0.10 |
| Orange wax “light ends”-Koster Keunan | 0.13 |
| Flexisorb AQ-50-ICT-Cartersville, GA | 0.2 |
| Sulfochem AEG-Chemron, Inc. | 5.0 |
| Magnesium sulfate heptahydrate | 4.0 |
| Glucopon 425N HH-Cognis | 2.0 |
| Milliken Brilliant Orange (colorant) | 0.004 |
| Novarome Orange Blast 91140 (fragrance) | 0.2 |

The orange wax was mixed into the Glucopon for abut 5 min. at room temperature, which substantially solubilized the wax. This was then mixed with the remaining components for about 15 min. at room temperature. A solution resulted. The pH of the composition was from about 4.5 to about 9.0.

### Example 2

### Testing #1

Ten abrasive-blasted carbon steel panels were coated with Carboline™ 890 white epoxy (Carboline Company, St. Louis, Mo.) and allowed to cure. The panels were then treated with three different samples as follows:

Sample #1-Sprayed with diluted formulation of Example 1 (at 2 oz/gallon water), then rinsed with tap water after 3 minutes and wiped clean.

Sample #2-Sprayed with undiluted example formulation of Example 1, then rinsed with tap water after 3 minutes and wiped clean.

Sample #3-Untreated control panels.

The panels were allowed to dry overnight, then measured individually for 60-degree gloss.

The panels were then exposed to continuous UV light in accordance with published ASTM G-154-00ae1 (which is incorporated herein by reference in its entirety) utilizing UVA-340 bulbs at 60 degrees Celsius for 300 hours. The panels were then removed from the test chamber, visually evaluated, and then the 60-degree gloss measured individually using a BYK 60 degree pocket gloss meter, from Mallinckrodt (Germany), calibrated prior to each set of gloss readings.

The results are shown in Table 1:

TABLE 1

Average %
Change in Gloss

| Test Sample # | After 300 hrs | After 500 hrs |
|---|---|---|
| 1 (diluted formulation) | −24.9 | −60 |
| 2 (undiluted formulation) | −17.6 | −52 |
| 3 (control) | −30.6 | −69 |

The results are indicative of the present invention reducing the degradation of gloss after being subjected to the UV light. It was observed that the diluted formulation provided at least about 300 hours and the undiluted formulation provided at least about 500 hours of demonstrable protection against loss of gloss.

### Example 3

### Testing #2

Car wash test on automotive painted surface

A front hood of a Porsche, which was painted yellow was used for this test. The paint was in fair condition.

For the purposes of the test, initial gloss of the surface to be tested was measured with a Tasco™ TMS-723 gloss checker, manufactured by Tasco Japan Co. Ltd. The measurement was done at 60 degrees.

The hood was divided into two zones-treated with diluted sample of the invention prepared according to the procedure in Example 1, at 2/oz per gallon of water and another zone untreated.

The ultraviolet source was provided by one each for each zone, GE Blacklite™ Indoor Spotlights, 75 watt, manufactured by General Electric Company. Standard floodlight holders with 110 volt power were used to supply the lights with current. Each floodlight was suspended at an equal distance and angle from the area to be tested. To verify the presence of ultraviolet radiation, Green Detex™ adhesive strips manufactured by Sessions of York of York, England were used. The presence of ultraviolet radiation was confirmed with the color change of these adhesive strips corresponding to the length of testing.

For a period of 4 weeks, the untreated side was sprayed each day until thoroughly wet with tap water to approximate rainfall. The treated side had the same daily spray of tap water, except that one time per week, the diluted product was reapplied to the area, then rinsed.

At the end of the testing, the loss in gloss was measured:

Untreated area % gloss loss=−5.3%

Treated area % gloss loss=+4.6%

It may be that with the each week application there was protection against UV and some slight improvement in gloss, which is not unusual with the alkyl polyglucosides.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. It should further be noted that any patents, applications and publications referred to herein are incorporated by reference in their entirety.

What is claimed is:

1. An aqueous cleaning and protecting composition, comprising
a) about 0.01 to about 10 weight percent of a surfactant;
b) about 1 to about 5 weight percent of a co-surfactant;
c) about 0.05 to about 5 weight percent of an antioxidant; and,
d) about 0.02 to about 5 weight percent of an ultraviolet absorbent.

2. The composition of claim 1, wherein said surfactant comprises at least one surfactant and at least one co-surfactant.

3. The composition of claim 1, wherein said surfactant comprises a material selected from the group consisting of alcohol sulfates, alkali metal and alkaline earth metals or ammonium salts of sulfate esters of C₈-C₁₂ alcohols, and mixtures thereof.

4. The composition of claim 1, wherein said surfactant is selected from the group consisting of sodium laurylsulfate, sodium 2-ethylhexylsulfate, lauryl triethanolammonium sulfate, sodium octylsulfate ammonium lauryl sulfate, ammonium laureth sulfate, cocamidopropyl betaine, and cocamide DEA.

5. The composition of claim 1, wherein said co-surfactant is an alkyl glycoside.

6. The composition of claim 1, wherein said alkyl glycoside is an alkyl polyglycoside.

7. The composition of claim 1, wherein said antioxidant is selected from the group consisting of vitamin A, vitamin E, orange wax, trihydroxy-flavanone, trihydroxy-methoxyflavanone, ferrolic acid, and caffeic acid.

8. The composition of claim 1, wherein said antioxidant is orange wax light ends or orange wax heavy ends.

9. The composition of claim 1, wherein said ultraviolet light absorber is selected from the group consisting of arylbenzotriazole, benzophenone and mixtures thereof.

10. The composition of claim 1, further comprising about 0.005 to about 1 weight percent of an antimicrobial preservative.

11. The composition of claim 1, further comprising about 0.1 to about 8 weight percent of a material selected from the group consisting of magnesium chloride, magnesium sulfate heptahydrate and mixtures thereof.

12. The composition of claim 1, further comprising a fragrance.

13. The composition of claim 1, further comprising a colorant.

14. The composition of claim 1, wherein the pH is from 4.5 to 9.0.

15. The composition of claim 1, further comprising 0.05 to 4.0 weight percent of a chelating agent.

16. The composition of claim 15, wherein said chelating agent comprises a material selected from the group consisting of sodium salts of ethylene diamine tetraacetic acid and sodium salts of polyacrylic acid.

17. The composition of claim 1, further comprising borax.

18. An aqueous cleaning and protecting composition, comprising:
a) about 3 to about 10 weight percent of a surfactant selected from the group consisting of ammonium lauryl sulfate, ammonium laureth sulfate, cocamidopropyl betaine, cocamide DEA and mixtures thereof;
b) about 1.5 to about 4 weight percent of alkyl glycoside;
c) about 0.1 to about 5 weight percent light ends orange wax; and,
d) about 0.02 to about 5 weight percent of benzotriazole.

19. The composition of claim 18, further comprising about 4 weight percent magnesium sulfate heptahydrate.

20. The composition of claim 18, further comprising about 0.1 weight percent dimethyl dimethyl hydantoin.

21. The composition of claim 18, further comprising about 0.05% by weight to about 4% by weight sodium salt of ethylenediamine tetraacetic acid.

22. A method of cleaning and preserving a surface, comprising the steps of:
a) wetting the surface to be cleaned and protected;
b) applying to the surface a composition according to the present invention as described above;
c) rinsing the surface with water; and
d) allowing the surface to dry.
